(19) United States
(12) Patent Application Publication
(10) Pub. No.: US 2013/0318008 A1
(43) Pub. Date: Nov. 28, 2013

(54) SYSTEM FOR MANAGING RETIREMENT INCOME AND A METHOD THEREOF

(71) Applicants: Adrian Gore, Sandton (ZA); Herschel Phillip Mayers, Johannesburg (ZA); Kenneth Steven Rabson, Johannesburg (ZA)

(72) Inventors: Adrian Gore, Sandton (ZA); Herschel Phillip Mayers, Johannesburg (ZA); Kenneth Steven Rabson, Johannesburg (ZA)

(73) Assignee: DISCOVERY LIFE LIMITED, Sandton (ZA)

(21) Appl. No.: 13/996,058

(22) PCT Filed: Jun. 30, 2011
(86) PCT No.: PCT/IB11/52875

§ 371 Date: Aug. 15, 2013

(30) Foreign Application Priority Data
Dec. 21, 2010 (ZA) 2010/09180

(51) Int. Cl. G06Q 40/06

(52) U.S. Cl. CPC G06Q 40/06
USPC 705/36 R

(57) ABSTRACT

A method and system for managing a retirement income fund includes recording a starting value of a retirement investment for an investor and calculating based on the starting value a guaranteed periodic income amount that the investor will receive for the rest of their life. A selection is received from the investor of at least one investment fund and of a periodic withdrawal amount. Based on the performance of the at least one investment fund, upper and lower parameters for the periodic withdrawal amount are calculated. The guaranteed periodic income amount is recalculated whereby if the selected periodic withdrawal amount is lower than the lower parameter then the guaranteed periodic income amount is increased, if the periodic withdrawal amount is higher than the upper parameter then the guaranteed periodic income amount is decreased and if the periodic withdrawal amount is between the upper and lower parameters then the guaranteed periodic income amount is left the same. The selected periodic withdrawal amount is periodically paid to the investor and the value of the retirement investment is recalculated based on the performance of the at least one investment fund and reducing the value of the retirement investment by the periodic withdrawal amount. If the value of the retirement investment has reached zero then ceasing to pay to the investor the periodic withdrawal amount but thereafter periodically paying the guaranteed periodic income amount. Finally, on the death of the investor, determining the value of the retirement investment and if this is greater than zero then paying to at least one beneficiary of the investor the value and ceasing to pay any further periodic amounts.

### BACKGROUND OF THE INVENTION

The present invention relates to a system for managing retirement income and a method thereof.

The system addresses the shortcoming of prior art systems by managing a retirement income of an investor to provide flexibility of draw downs and fund choice together with a minimum level of guaranteed income that increases with investment performance for the whole of the investor's life.

In addition, the investor does not lose his fund value on death as is the case with fixed annuities.

There are no existing products that provide these advantages to investors and the system of the present invention seeks to address this.

### SUMMARY OF THE INVENTION

According to one example embodiment there provided a method of managing a retirement income fund, the method including:
recording a starting value of a retirement investment for an investor;
calculating based on the starting value a guaranteed periodic income amount that the investor will receive for the rest of their life;
receiving a selection from the investor of at least one investment fund and of a periodic withdrawal amount;
calculating, based on the performance of the at least one investment fund, upper and lower parameters for the periodic withdrawal amount;
recalculating the guaranteed periodic income amount whereby if the selected periodic withdrawal amount is lower than the lower parameter then the guaranteed periodic income amount is increased, if the periodic withdrawal amount is higher than the Upper parameter then the guaranteed periodic income amount is decreased and if the periodic withdrawal amount is between the upper and lower parameters then the guaranteed periodic income amount is left the same;
periodically instructing a server of a financial institution to pay to the investor the selected periodic withdrawal amount;
recalculating the value of the retirement investment based on the performance of the at least one investment fund and reducing the value of the retirement investment by the periodic withdrawal amount;
determining if the value of the retirement investment has reached zero and if so ceasing to instruct the server of the financial institution to pay to the investor the periodic withdrawal amount but thereafter periodically instructing the server to pay the guaranteed periodic income amount; and
on the death of the investor, determining the value of the retirement investment and if this is greater than zero then instructing the server of the financial institution to pay to at least one beneficiary of the investor the value and ceasing to pay any further periodic amounts.

The calculating of the upper and lower parameters may use the maximum historical value of the fund in which the investment is invested.

The recalculating of the guaranteed periodic income amount in one example takes into account the age of the investor at the time of the recalculation and the gender of the investor.

According to another example embodiment there provided a system for managing a retirement income fund, the system including:
a memory;
a receiving module for receiving:
(i) a starting value of a retirement investment for an investor;
(ii) a selection from the investor of at least one investment fund;
(iii) personal details of the investor;
(iv) a periodic withdrawal amount; and
(v) periodically receiving investment performance information relating to the performance of the at least one investment fund for a past period;
a calculating module for calculating based on the starting value of the investment and on the personal details of the investor a guaranteed periodic income amount that the investor will receive for the rest of their life, and in addition periodically recalculating the guaranteed periodic income amount based on the performance of the at least one investment fund and on the selection of the periodic withdrawal amount whereby based on the performance of the at least one investment fund, upper and lower parameters for the periodic withdrawal amount are calculated and if the selected periodic withdrawal amount is lower than the lower parameter then the guaranteed periodic income amount is increased, if the periodic withdrawal amount is higher than the upper parameter then the guaranteed periodic income amount is decreased and if the periodic withdrawal amount is between the upper and lower parameters then the guaranteed periodic income amount is left the same, the calculation module further recalculating the value of the retirement investment based on the performance of the at least one investment fund and reducing the value of the retirement investment by the periodic withdrawal amount; and
a payments module to periodically instruct a server of a financial institution to pay to the investor the selected periodic withdrawal amount and to determine if the value of the retirement investment has reached zero and if so ceasing to instruct the server of the financial institution to pay to the investor the periodic withdrawal amount but thereafter periodically instructing the server to pay the guaranteed periodic income amount, the payments module further on the death of the investor, determining the value of the retirement investment and if this is greater than zero then instructing the server of the financial institution to pay to at least one beneficiary of the investor the value and ceasing to pay any further periodic amounts.

### BRIEF DESCRIPTION OF THE DRAWING

FIG. 1 is a block diagram illustrating an example system to implement the methodologies described herein.

### DESCRIPTION OF EMBODIMENTS

The present invention relates to a system for managing a retirement income.

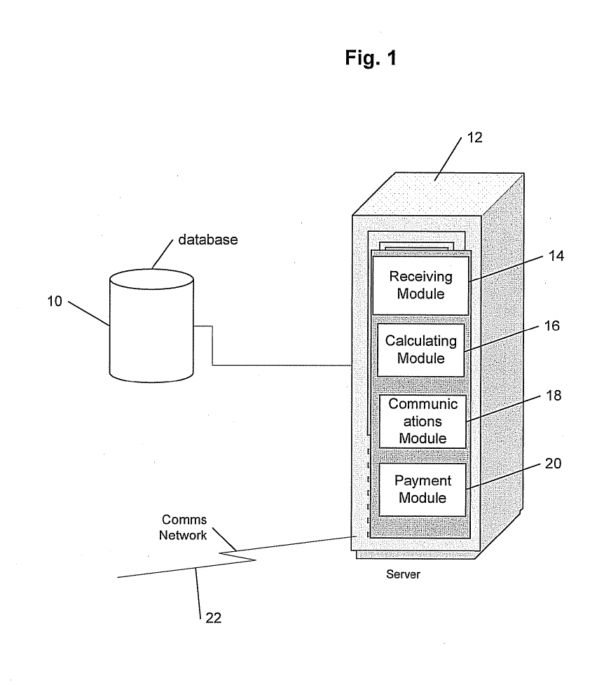

Referring to FIG. 1, a server 12 includes a number of modules to implement the present invention.

The server, also includes a network adaptor (not shown) to communicate over at least one communication network 22.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 12 is connected to a memory 10 in the form of a database.

A receiving module 14 receives and records a starting value of a first component of a retirement investment for an investor in the database 10.

A calculating module 16 calculates, based on the starting value, a guaranteed periodic income amount that the investor will receive for the rest of their life.

In addition, the receiving module 14 receives and records a selection from the investor of at least one first investment fund.

The calculating module 16 periodically recalculates the guaranteed periodic income amount based on the performance of the at least one investment fund and if the investment fund performs well then the calculating module 16 increases the guaranteed periodic income amount but if the investment fund does not perform well then the guaranteed periodic income amount is maintained as last calculated.

The receiving module 14 receives and records a starting value of a second component of a retirement investment for the investor in the memory 10.

In addition, the receiving module 14 receives a selection from the investor of at least one second investment fund and stores this in the memory 10.

The calculating module 16 periodically determines the performance of the at least one second investment fund and based on the performance of the at least one second investment fund provides the investor with a range of allowable amounts for an additional periodic income amount.

A communications module 18 communicates the range of allowable amounts for an additional periodic income amount to the investor.

The receiving module 14 then receives a selection from the investor of the additional periodic income amount.

A payment module 20 periodically instructs a server of a financial institution to pay to the investor the guaranteed periodic income amount and the additional periodic income amount.

The calculating module 16 then reduces the value of the second component of the retirement investment fund by the additional periodic income amount.

In addition, the calculating module 16 determines if the value of the second component of the retirement investment fund has reached zero and if so the payment module 20 ceases to instruct the server of the financial institution to pay to the investor the additional periodic income amount but continues to instruct the server to pay the calculated guaranteed periodic income amount.

On the death of the investor, the calculating module 16 determines the value of the retirement investment fund and if this is greater than zero then instructs the server of the financial institution, typically via the communications network 22, to pay to the investor the value and ceasing to pay to the investor any further periodic amounts.

Thus it will be appreciated that there are four parts to the retirement income product implemented by the system:
1. The starting guaranteed minimum that the income can never drop below;
2. This minimum guarantee ratchets up over time;
3. On a year by year basis, the investor can draw down more than his actual guaranteed minimum if investment performance is good; and
4. On death, any remaining fund is paid to the investor's beneficiaries or if the fund runs out and the investor is still alive, his income will in any event continue for life.

It should be noted that the guaranteed minimum can be reduced if the investor selects a drawdown that is higher than the recommended rate.

An example method implemented by the above system will now be described.

The guaranteed periodic income is calculated as follows based on the gender and age of the investor and on the starting value received from the investor.

| | Starting monthly guarantee |
|---|---|
| Male Investors | as a percentage of the |
| Age next | initial contribution |
| 56, younger than 61 | 4.50% |
| 61, younger than 66 | 4.75% |
| 66, younger than 71 | 5.00% |
| 71, younger than 76 | 5.25% |

So, for example, if an investor aged 56 invests a starting value of R1,000,000, he will be guaranteed 4.5%×R1,000,000=R45,000 per annum for life.

It will be appreciated that in this example the period used to determine the periodic income is a year but that this could be any suitable period.

The investor selects a fund for the starting value to be invested in and the guaranteed periodic income increases over time if the performance of the investment fund is good in accordance with the table below.

| Age | Increase factor |
|---|---|
| 56 | 2.8% |
| 57 | 2.9% |
| 58 | 3.0% |
| 59 | 3.1% |
| 60 | 3.2% |

So for example, if the investor now aged 57 has a fund where the starting value fund grows by R100,000, the investors guaranteed income will grow by 100,000×2.9%=2,900 and the total of R47,900 will be guaranteed for the rest of the investor's life.

In addition, the investor can draw down more than the guaranteed minimum from his fund without affecting Na guarantee as an additional periodic income amount.

Even though the investor's guarantee is R47,900 above, he may be able to still draw more out of his fund than this provided his fund has grown. the amount is shown in the table below:

| Previous years | |
|---|---|
| return of the Fund | Max drawdown |
| Less than 0% | Guaranteed amount |
| Between 0% and 5% | Max(Guaranteed amount, 7.5% × Fund value) |
| Between 5% and 10% | Max(Guaranteed amount, 10.0% × Fund value) |
| Between 10% and 15% | Max(Guaranteed amount, 12.5% × Fund value) |
| Between 15% and 20% | Max(Guaranteed amount, 15.0% × Fund value) |
| 20% or more | Max(Guaranteed amount, 17.5% × Fund value) |

So in the case above, if the investor had R1,200,000 invested in the fund, his guarantee was R47,900 and the fund grew by 5%, he would actually be able to draw 7.5%×R1,200,000=R90,000 and still have a guarantee that this would never drop below the guaranteed R47,900.

Of course, the investor is free to draw down as much as 17.5% of his fund but any draw down above the maximum as per the table above will reduce the guarantee in the future.

In order to implement the methodology described above, the system manages the investor funds as follows. When the investor's money is received at a financial institution, it is divided into two components:
1.
The majority of the annuity fund will be invested in funds which are CPPI products. If an investor invests R100,000 in a fund, this means that he will be guaranteed at least R80,000 regardless of market conditions. This R80,000 will increase as the fund unit price increases. In order to provide the annuity's guaranteed income for whole of life, this guaranteed minimum value is used;
The life expectancy of the person is calculated based on his age and the guaranteed minimum value of the fund is divided by this. So, for example, if the investor is expected to live 20 years, it is know that it will be possible to provide him with R80,000/20=R4,000 per year as long as he remains invested in the fund. Each year that the investor survives, any possible increase in the guaranteed value is divided it by the remaining life expectancy so there is a ratcheting up guaranteed income.

2.
The second component is a bond portfolio designed to provide an income for life and the remainder on death in the same manner as a fixed interest annuity.
A combination of these two components say 70% in the 1st and 30% in the 2nd will provide the starting guarantees in the table above.

In another embodiment, a starting value of a retirement investment for an investor is received by receiving module 14.

The calculations module 16 calculates based on the starting value a guaranteed periodic income amount that the investor will receive for the rest of their life.

The investor's age at inception and gender can also be used to determine the guaranteed periodic income which is expressed as a percentage of the total net investment. An example is set out in the table below:

| Age at next birthday | Male Investors | Female Investors |
|---|---|---|
| 56 to 60 | 3.25% per year | 3.00% per year |
| 61 to 65 | 3.50% per year | 3.25% per year |
| 66 to 70 | 3.75% per year | 3.50% per year |
| 71 and older | 4.25% per year | 4.00% per year |

So, for example, a 56-year old male with a total net investment of R1,000,000 would have a guaranteed periodic income of R1,000,000×3.25%=R32,500 per year where the period in this example is a year.

The receiving module also receives a selection from the investor of at least one investment fund.

In an example embodiment, the total net investment is invested in the investor's choice of investment fund, typically in an Annuity Escalator Fund. Each Annuity Escalator Fund provides a guarantee that the Annuity Escalator unit will never fall below 80% of the highest value the Annuity Escalator Fund has ever reached as a result of market falls.

The calculation module 16, calculates based on the performance of the at least one investment fund, upper and lower parameters for the periodic withdrawal amount.

In one example, the investor may choose between 2.5% and 17.5% of the investment fund per annum for their periodic withdrawal amount. However, to maintain the guaranteed periodic income, the investor shouldn't select an annuity percentage in excess of 80% of the Annuity Escalator's growth in the previous year. This is the upper parameter in the example and should the investor select more, the guaranteed periodic income will be reduced.

For example, the 56-year old male with a total net investment of R1,000,000 would have a guaranteed minimum income of R1,000,000×3.25%=R32,500 per year. However, he may choose an actual annuity for the year of 5% of his total net investment or 5%×R1,000,000=R50,000.

After the investor has selected their periodic withdrawal amount, the guaranteed periodic income amount is recalculated whereby if the selected periodic withdrawal amount is lower than the lower parameter than the guaranteed periodic income amount is increased, if the periodic withdrawal amount is higher than the upper parameter then the guaranteed periodic income amount is decreased and if the periodic withdrawal amount is between the upper and lower parameters then the guaranteed periodic income amount is left the same.

Each year, if the Annuity Escalator Fund the investor has chosen reaches a new highest value, the guaranteed minimum income that he will receive will increase to a new level for the rest of his life.

The increase will depend on the number of Annuity Escalator units the investor has at the end of the year and on calculated age factors that incorporate:
The investor's age (the factor increase with age)
The investor's annuity percentage chosen (the more he chooses, the less his Guaranteed Minimum Income increases. If he chooses a lower annuity percentage, his Guaranteed Minimum Income has the potential for higher growth.)
The investor's gender (female rates are lower than males due to a higher average life expectancy).

An example of how this could be implemented is set out in the tables below.

| | Chosen annuity percentage | | | |
|---|---|---|---|---|
| | | Greater than | Greater than | |
| Males | Less than | 5% and less | 7.5% and less | |
| age | or equal | than or equal | than or equal | Greater |
| next | to 5% | to 7.5% | to 10% | than 10% |
| 56-60 | 3.60% | 2.80% | 2.40% | 1.80% |
| 61-65 | 4.10% | 3.10% | 2.70% | 2.00% |
| 66-70 | 4.70% | 3.60% | 3.00% | 2.30% |
| 71-75 | 5.40% | 4.10% | 3.50% | 2.60% |
| 76-80 | 6.30% | 4.80% | 4.10% | 3.10% |
| 81-85 | 7.50% | 5.70% | 4.80% | 3.70% |
| 86-88 | 9.20% | 7.10% | 6.00% | 4.50% |
| 89-90 | 10.80% | 8.20% | 6.90% | 5.30% |
| 91-92 | 12.30% | 9.30% | 7.90% | 6.00% |
| 93-94 | 14.60% | 11.10% | 9.40% | 7.10% |
| 95-96 | 18.70% | 14.20% | 12.00% | 9.10% |
| 97+ | 27.10% | 21.60% | 18.50% | 14.00% |

| | Chosen annuity percentage | | | |
|---|---|---|---|---|
| | | Greater than | Greater than | |
| Females | Less than | 5% and less | 7.5% and less | |
| age | or equal | than or equal | than or equal | Greater |
| next | to 5% | to 7.5% | to 10% | than 10% |
| 56-60 | 3.10% | 2.40% | 2.10% | 1.60% |
| 61-65 | 3.50% | 2.70% | 2.30% | 1.80% |
| 66-70 | 4.10% | 3.10% | 2.70% | 2.00% |
| 71-75 | 4.80% | 3.60% | 3.10% | 2.40% |
| 76-80 | 5.60% | 4.30% | 3.60% | 2.80% |
| 81-85 | 6.80% | 5.20% | 4.40% | 3.40% |
| 86-88 | 8.50% | 6.50% | 5.50% | 4.30% |
| 89-90 | 10.00% | 7.70% | 6.50% | 5.00% |
| 91-92 | 11.50% | 8.80% | 7.50% | 5.80% |
| 93-94 | 13.70% | 10.50% | 8.90% | 6.90% |
| 95-96 | 17.70% | 13.50% | 11.50% | 8.80% |
| 97+ | 27.10% | 20.80% | 17.80% | 13.70% |

An example of the above being implemented is as follows:

The 56 year old male mentioned above is now 57. Suppose his chosen Annuity Escalator units had grown by 10% from R1.00 to R1.10 and his 80% highest value guarantee has grown from R0.80 to R0.88 over the year. Assume that after annuity payments and fees, the number of Annuity Escalator units he has is 950 000. His fund value at the end of the year is therefore 950,000×R1.10=R1,045,000.

The value that his 80% highest value guarantee has increased by is (R0.88−R0.80)×950,000=R76,000. At the end of the year, the investor may choose an annuity income percentage of up to 8% without impacting his Minimum Guaranteed Income (80%×10%). He decides that he wants to grow his guarantee as much as possible and therefore chooses an annuity percentage of 5% again. The age factor in this case is therefore 3.60%. His annual Guaranteed Minimum Income will therefore increase by 3.60%×R76,000=R2,736. His total guaranteed minimum income will therefore increase to R32,500+R2,736=R35,236. The guaranteed minimum income will be payable for life even if the investment fund runs out.

The periodic annual income that the investor will receive is 5%×R1,045,000=R52,250.

Another example is illustrated as follows.

On a net investment of R1 500 000, the initial annual Guaranteed Minimum Income for a female investor aged 73 next is R60 000. This is calculated as R1 500 000×4.00%. Her chosen initial annuity percentage, however, is 5% giving her an annuity income of R75,000.

At the first policy anniversary, the Annuity Escalator Fund value is R1 508 700 as the Annuity Escalator Fund's unit price had grown by 7%, from 100 to 107.

The recommended maximum annuity percentage is the higher of:
80% of 7%=5.6%
60 000/1 508 700=3.98%

The recommended maximum annuity percentage is therefore 5.6%.

She currently has 14,100 units of Annuity Escalator Fund which has a guaranteed unit price of 85.6. The guaranteed unit price at the previous policy anniversary was 80. Since the guaranteed unit price has increased, her Guaranteed Minimum Income will also increase

Based on her age (74 next) and chosen annuity income percentage (5.6%) the appropriate age factor is 3.6%. Her Guaranteed Minimum Income will increase by: 14,100×(85.6−80)×3.60%=R2 842.56

This increase will be added to her current Guaranteed Minimum income of R59 712 giving her a new Guaranteed Minimum Income of R62 842.56 The payments module 20 periodically instructs a server of a financial institution to pay to the investor the selected periodic withdrawal amount.

The payments module 20 then recalculates the value of the retirement investment based on the performance of the at least one investment fund and reduces the value of the retirement investment by the periodic withdrawal amount. It will be appreciated that this recalculation in another embodiment could be performed by the calculation module 16.

Finally, the payments module 20 determines if the value of the retirement investment has reached zero and if so ceasing to instruct the server of the financial institution to pay to the investor the periodic withdrawal amount but thereafter periodically instructing the server to pay the guaranteed periodic income amount.

On the death of the investor, the value of the retirement investment is determined and if this is greater than zero than the payments module 20 instructs the server of the financial institution to pay to at least one beneficiary of the investor the value and ceasing to pay any further periodic amounts.

Should the investor survive for a long time and his fund runs out the retirement income fund managers will keep paying the annuity income. If at any stage the investor dies, he will keep the leftover of the fund if any.

Thus it will be appreciated that the fund is designed to provide unlimited upside potential in bull markets, while offering downside protection in bear markets. Investors are protected at a level of at least 80% of the highest value the fund has ever reached. The fund is calculated with reference to a mix of assets that dynamically rebalances between an underlying riskier asset and a cash component on an ongoing basis. This rebalancing is done according to a defined algorithm. As the performance of the riskier asset improves, the allocation to the riskier asset increases. Should the performance of the riskier asset fall, the allocation to the riskier asset decreases in favour of the cash component thereby protecting the fund against further falls. The algorithm is designed so that at 80% of the highest value ever reached, the fund will be entirely exposed to cash. When the cash earns interest, the fund will then releverage back into the underlying riskier asset.

In one example, investors can also choose geared funds that give them the same ‘downside’ protection of at least 80% of the highest level that the fund has ever reached. The geared funds are calculated with reference to the rebalancing between the riskier asset and the cash component in a similar way to the Funds described above, except, that when the riskier asset is performing well, the geared fund is based on using gearing (borrowing money, internally within the fund at a rate of SAFEX+0.8%) to give up to 120% exposure to the riskier asset. Investors will earn any excess returns on the borrowed money that the riskier asset earns over SAFEX+0.8%.

Finally, in an alternate embodiment, the methodology could be implemented by an insurer, for example, holding the assets invested so the insured person doesn't actually own any portion of a fund. The insurer rather gives a return that is based on the funds that are selected and a payment based on a withdrawal rate. Also, when the insured person dies, because the insurer has been tracking assets for him, he is given a payment that is based on this.

In reality, the insurer matches the assets that are chosen by purchasing their own assets to replicate the return.

Thus it will be appreciated that the system provides the investor with the following advantages:
Flexibility to choose from a range of funds (fund and geared funds which provide unlimited upside potential with downside protection). A portion of the investment will also be held in a bond portfolio.
Guaranteed income for life—this guarantee ratchets up with market growth (this guarantee is in Rand terms and not a percentage of the fund).
Flexibility regarding the withdrawal rate in line with a linked annuity resulting in a personalised income withdrawal.
A death benefit of linked to the investor's remaining fund value at the time of death so that the remaining assets transfer to beneficiaries

1. A method of managing a retirement income fund, the method including:
recording, with a computer, a starting value of a retirement investment for an investor;
calculating, with a computer, based on the starting value a guaranteed periodic income amount that the investor will receive for the rest of their life;
receiving, with a computer, a selection from the investor of at least one investment fund and of a periodic withdrawal amount;
calculating, with a computer, based on the performance of the at least one investment fund, upper and lower parameters for the periodic withdrawal amount;
recalculating, with a computer, the guaranteed periodic income amount whereby if the selected periodic withdrawal amount is lower than the lower parameter then the guaranteed periodic income amount is increased, if the periodic withdrawal amount is higher than the upper parameter then the guaranteed periodic income amount is decreased and if the periodic withdrawal amount is between the upper and lower parameters then the guaranteed periodic income amount is left the same;
periodically instructing, with a computer, a server of a financial institution to pay to the investor the selected periodic withdrawal amount;
recalculating, with a computer, the value of the retirement investment based on the performance of the at least one investment fund and reducing the value of the retirement investment by the periodic withdrawal amount;
determining, with a computer, if the value of the retirement investment has reached zero and if so ceasing to instruct the server of the financial institution to pay to the investor the periodic withdrawal amount but thereafter periodically instructing the server to pay the guaranteed periodic income amount; and
on the death of the investor, determining, with a computer, the value of the retirement investment and if this is greater than zero then instructing the server of the financial institution to pay to at least one beneficiary of the investor the value and ceasing to pay any further periodic amounts.

2. A method according to claim 1 wherein the calculating of the upper and lower parameters uses the maximum historical value of the fund in which the investment is invested.

3. A method according to claim 1 wherein the recalculating of the guaranteed periodic income amount takes into account the age of the investor at the time of the recalculation.

4. A method according to claim 1 wherein the recalculating of the guaranteed periodic income amount takes into account the gender of the investor.

5. A computer system for managing a retirement income fund, the system including:
a memory;
a receiving module for receiving:
(i) a starting value of a retirement investment for an investor;
(ii) a selection from the investor of at least one investment fund;
(iii) personal details of the investor;
(iv) a periodic withdrawal amount; and
(v) periodically receiving investment performance information relating to the performance of the at least one investment fund for a past period;
a calculating module for calculating based on the starting value of the investment and on the personal details of the investor a guaranteed periodic income amount that the investor will receive for the rest of their life, and in addition periodically recalculating the guaranteed periodic income amount based on the performance of the at least one investment fund and on the selection of the periodic withdrawal amount whereby based on the performance of the at least one investment fund, upper and lower parameters for the periodic withdrawal amount are calculated and if the selected periodic withdrawal amount is lower than the lower parameter then the guaranteed periodic income amount is increased, if the periodic withdrawal amount is higher than the upper parameter then the guaranteed periodic income amount is decreased and if the periodic withdrawal amount is between the upper and lower parameters then the guaranteed periodic income amount is left the same, the calculation module further recalculating the value of the retirement investment based on the performance of the at least one investment fund and reducing the value of the retirement investment by the periodic withdrawal amount; and
a payments module to periodically instruct a server of a financial institution to pay to the investor the selected periodic withdrawal amount and to determine if the value of the retirement investment has reached zero and if so ceasing to instruct the server of the financial institution to pay to the investor the periodic withdrawal amount but thereafter periodically instructing the server to pay the guaranteed periodic income amount, the payments module further on the death of the investor, determining the value of the retirement investment and if this is greater than zero then instructing the server of the financial institution to pay to at least one beneficiary of the investor the value and ceasing to pay any further periodic amounts.

6. A computer system according to claim 5 wherein the calculating of the upper and lower parameters uses the maximum historical value of the fund in which the investment is invested.

7. A computer system according to claim 5 wherein the recalculating of the guaranteed periodic income amount takes into account the age of the investor at the time of the recalculation.

8. A computer system according to claim 5 wherein the recalculating of the guaranteed periodic income amount takes into account the gender of the investor.
